(19) United States
(12) Patent Application Publication
(10) Pub. No.: US 2026/0154112 A1
(43) Pub. Date: Jun. 4, 2026

(54) SYSTEMS AND METHODS FOR DYNAMICALLY SCALING RESOURCES

(71) Applicant: The Toronto-Dominion Bank, Toronto (CA)

(72) Inventors: Pranay Chander GUPTA, Toronto (CA); Tanvi Shirish DATAR, Toronto (CA); Asad JOHEB, Toronto (CA)

(73) Assignee: The Toronto-Dominion Bank, Toronto (CA)

(21) Appl. No.: 18/964,866

(22) Filed: Dec. 2, 2024

(51) Int. Cl. G06F 9/50

(52) U.S. Cl. CPC G06F 9/5027

(57) ABSTRACT

A processor-implemented method and system are described. The method may include: determining, based on one or more parameters of a resource demand message, that the resource demand message represents a resource scaling request message; and in response to determining that the resource demand message represents a resource scaling request message, initiating a resource scaling technique including adjudicating a resource scaling request indicated by the resource scaling request message; providing a notification of an outcome of the adjudication of the resource scaling request to a computing device; in response to receiving, from the computing device, input including an indication to proceed based on the outcome of the adjudication of the resource scaling request, generating a message based on the resource demand message and in a real-time messaging format; and providing a scaled resource via a response to the resource demand message, the response including a transmission of the generated message.

### FIELD

The present disclosure relates to resource availability and dynamic resource allocation in computer systems and, more particularly, to computer systems and computer-implemented methods for dynamically scaling resources.

### BACKGROUND

Computer systems use various computing resources. Often, computer systems need to dynamically scale resources to meet demand.

Various scaling strategies exist that can be employed to dynamically scale resources. For example, autoscaling may be used to scale resources. Unfortunately, sometimes autoscaling latency may be significant and this may impact application availability. Autoscaling may also be complex and lead to over-provisioning or under-provisioning of resources, resulting in wasted resources or performance issues. Autoscaling may also limit the ability to manually manage resources or troubleshoot issues. In addition, autoscaling may rely on accurate and timely monitoring data to make informed decisions. Poor monitoring or inaccurate data may lead to suboptimal scaling and performance issues.

It would be advantageous to provide for enhanced scaling of resources.

### BRIEF DESCRIPTION OF THE DRAWINGS

Reference will now be made, by way of example, to the accompanying drawings which show example embodiments of the present application, and in which:

FIG. 1 shows a schematic diagram illustrating an operating environment of an example embodiment according to the subject matter of the present application;

FIG. 2 shows a high-level schematic diagram of the client device, first computing system and second computing system of FIG. 1;

FIG. 3 shows a simplified organization of software modules stored in a memory of the example computing systems of FIG. 2;

FIG. 4 shows, in block diagram form, an example embodiment of the data store of FIG. 1;

FIG. 5 is a flowchart showing operations performed in initiating a resource scaling technique, according to an example embodiment;

FIG. 6 shows, in flowchart form, a method of performing a resource scaling technique, according to an example embodiment;

FIG. 7 shows, in flowchart form, a method of adjudicating a resource scaling request, according to an example embodiment; and

FIG. 8 is an example notification interface for approving fulfillment of a resource demand and resource scaling request.

Similar reference numerals may have been used in different figures to denote similar components.

### DETAILED DESCRIPTION OF EXAMPLE EMBODIMENTS

In one aspect, the present application describes a system. The system may include a communications module; one or more processors coupled to the communications module; and a memory coupled to the one or more processors. The memory may store instructions that, when executed by the system, cause the system to obtain one or more parameters of a resource demand message; determine, based on the one or more parameters of the resource demand message, that the resource demand message represents a resource scaling request message; and in response to determining that the resource demand message represents a resource scaling request message, initiate a resource scaling technique, the resource scaling technique including: adjudicating a resource scaling request indicated by the resource scaling request message; providing a notification of an outcome of the adjudication of the resource scaling request to a computing device; in response to receiving, from the computing device, input including an indication to proceed based on the outcome of the adjudication of the resource scaling request, generating a message based on the resource demand message and in a real-time messaging format; and providing a scaled resource via a response to the resource demand message, the response including a transmission of the generated message.

In some implementations, the resource demand message may include urgency data indicating an urgency of the resource demand message and wherein the resource scaling technique is based on the urgency of the resource demand message.

In some implementations, the instructions, when executed by the system, may further cause the system to prioritize initiating the resource scaling technique based on an urgency of the resource demand message.

In some implementations, adjudicating the resource scaling request may be based on a purpose indicated by the one or more parameters of the resource demand.

In some implementations, adjudicating the resource scaling request may be based on a likelihood of a positive outcome to use of the scaled resource.

In some implementations, adjudicating the resource scaling request may be based on a resource scaling amount included in the resource demand message.

In some implementations, the one or more parameters of the resource demand message may indicate a resource demand amount and a scaling request amount to cover at least a portion of the resource demand amount.

In some implementations, the transmission of the message may include use of an application programming interface configured to facilitate a real-time transfer.

In some implementations, the instructions may further cause the computer system to receive the resource demand message via a real-time transfer protocol.

In some implementations, the instructions, when executed by the system, may further cause the system to generate a resource scaling policy based on the resource demand message, and wherein the indication to proceed further indicates acceptance of the resource scaling policy.

In yet another aspect, the present application describes a computer-implemented notification method. The computer-implemented notification method may include obtaining one or more parameters of a resource demand message; determining, based on the one or more parameters of the resource demand message, that the resource demand message represents a resource scaling request message; and in response to determining that the resource demand message represents a resource scaling request message, initiating a resource scaling technique, the resource scaling technique including: adjudicating a resource scaling request indicated by the resource scaling request message; providing a notification of an outcome of the adjudication of the resource scaling request to a computing device; in response to receiving, from the computing device, input including an indication to proceed based on the outcome of the adjudication of the resource scaling request, generating a message based on the resource demand message and in a real-time messaging format; and providing a scaled resource via a response to the resource demand message, the response including a transmission of the generated message.

In some implementations, the method may further include prioritizing the initiation of the resource scaling technique based on an urgency of the resource demand message.

In some implementations, the method may further include receiving the resource demand message via a real-time transfer protocol.

In some implementations, the method may further include generating a resource scaling policy based on the resource demand message, and wherein the indication to proceed further indicates acceptance of the resource scaling policy.

In yet another aspect, present application describes a non-transitory computer-readable storage medium comprising processor-executable instructions which, when executed, may configure one or more processors to obtain one or more parameters of a resource demand message; determine, based on the one or more parameters of the resource demand message, that the resource demand message represents a resource scaling request message; and in response to determining that the resource demand message represents a resource scaling request message, initiate a resource scaling technique, the resource scaling technique including: adjudicating a resource scaling request indicated by the resource scaling request message; providing a notification of an outcome of the adjudication of the resource scaling request to a computing device; in response to receiving, from the computing device, input including an indication to proceed based on the outcome of the adjudication of the resource scaling request, generating a message based on the resource demand message and in a real-time messaging format; and providing a scaled resource via a response to the resource demand message, the response including a transmission of the generated message.

In yet a further aspect, the present application describes a non-transitory computer-readable storage medium storing processor-readable instructions that, when executed, configure one or more processors to perform any of the methods described herein. Also described in the present application is a computing device comprising: one or more processors, memory, and an application containing processor-executable instructions that, when executed, cause the one or more processors to carry out at least one of the methods described herein. In this respect, the term processor is intended to include all types of processing circuits or chips capable of executing program instructions.

Other aspects and features of the present application will be understood by those of ordinary skill in the art from a review of the following description of examples in conjunction with the accompanying figures.

In the present application, the term “and/or” is intended to cover all possible combinations and sub-combinations of the listed elements, including any one of the listed elements alone, any sub-combination, or all of the elements, and without necessarily excluding additional elements.

In the present application, the phrase “at least one of . . . or . . . ” is intended to cover any one or more of the listed elements, including any one of the listed elements alone, any sub-combination, or all of the elements, without necessarily excluding any additional elements, and without necessarily requiring all of the elements.

In the present application, reference may be made to the terms “automatic” or “automatically”. In some embodiments, these terms may cover an action or operation that does not require outside (human or machine) intervention in order to be triggered, executed, carried out, performed, and/or completed.

In the present application, reference may be made to the term “real-time”. In at least some embodiments, real-time is defined as being within seconds. Certain factors, such as network traffic, may limit the immediacy of real-time transfers and/or processing of resource demands.

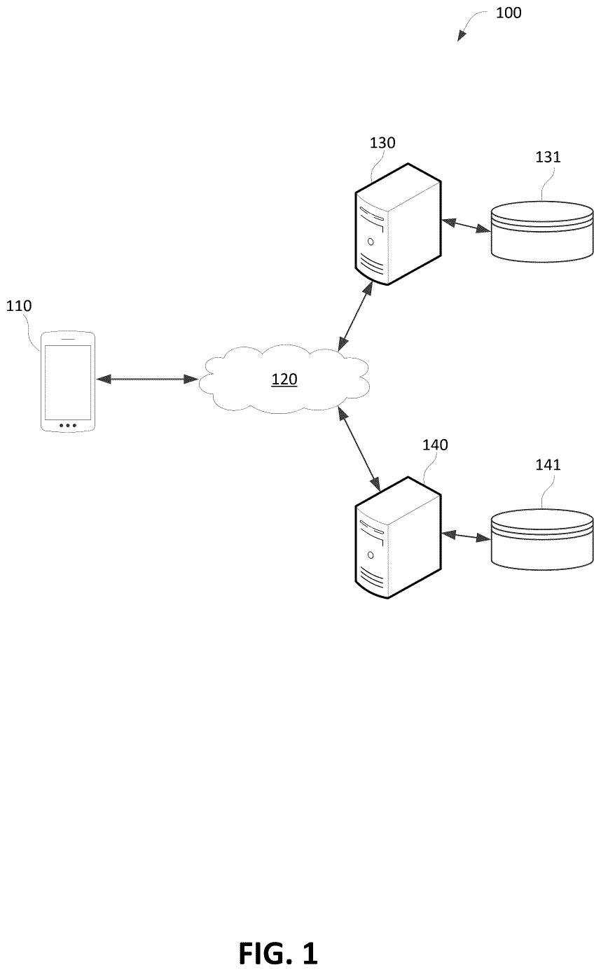

FIG. 1 shows a schematic diagram illustrating an operating environment of an example embodiment. The various components cooperate to provide a system 100 that may be used, for example, to perform an operation.

The operating environment in this example includes a client device 110, first system 130, and second system 140. In some embodiments, the operating environment may include one or more client devices or a plurality of client devices, which may include the client device 110.

The client device 110 may be associated with an entity, such as a user of the client device 110. In some embodiments, the operator of the client device 110 may be an employee of the entity. The entity may have one or more profiles and/or accounts that may be stored in a data store 131 associated with, provided by and/or corresponding to the first computing system 130. Each profile may also include a record that may be or represent account data or other data maintained by the first system 130. The record may include data of various types and the nature of the data will depend on the nature of the first system 130. By way of example, in some implementations, the record may include, for example, documents and/or other data stored or uploaded by, or on behalf of a user. Such documents and/or data may include, for example, any one or more of: user preferences, indications of consent or authorization, digital identity data such as stored identity information or documentation, transactional information, or other types of documents and/or data. The transactional information may include historical data transfers for the account.

The first system 130 may be configured to verify authentication information received from the client device 110 as corresponding to one or more profiles, accounts and/or authentication data maintained by the first system 130.

In some embodiments, the first system 130 may provide a front-end interface that allows the client device 110 to interact with the first system 130. For example, the first system 130 may provide one or more graphical user interfaces (GUIs) to the client device 110. By way of example, the first system 130 may provide, to the client device 110, a user interface for uploading data in an authenticated session. The user interface provided to the client device 110 may be an interface for receiving user input associated with a resource request, including a resource demand. A resource demand may indicate a transfer of a resource between the account associated with the first system 130 and the account associated with the second system 140 and/or a request for a transfer of a resource.

The first system 130 may be managed, operated, controlled by and/or associated with an entity that is an agent of a first account holder, which may be a user of the client device 110. The client device 110 may be managed, operated or controlled by the first account holder. The first account holder may be a customer (e.g. a corporate/business customer) or client of the entity or otherwise associated with the entity. In some embodiments, the first account holder is a requestee or transferor of a data or resource transfer.

The first system 130 may allocate, consume, maintain, track, manage, and/or provide computing resources to the entity associated with the client device 110. A computing resource may be of a variety of types. The computing resources may, for example, be memory or processor cycles. In some embodiments, the computing resource may be a network resource, such as, for example, bandwidth. In some embodiments, the computing resource is a storage resource, such as memory that is used for long-term storage, including for example non-transitory storage such as space in a hard disk drive (HDD), solid state disk drive (SSDD), etc. In some embodiments, a resource may be or include stored value, such as a digital asset, which may be represented in a data store. For example, the first computing system 130 may be coupled to a data store 131, which may be provided in secure storage. The secure storage may be provided internally within the first computing system 130 or externally. The secure storage may, for example, be provided remotely from the first computing system 130. For example, the secure storage may include one or more data centers. The first system 130 may store data regarding one or more resources in data store 131.

The first system 130 may further store data regarding users or customers associated with the first system 130 in first data store 131. The first data store 131 may include records associated with a plurality of entities. For example, the records may be for a plurality of accounts and at least some of the records may define or store resources. For example, the records may define a quantity of resources. For example, the entity that is associated with the client device 110 may be associated with an account having one or more records in the database. The records may reflect a quantity of stored resources that are associated with the entity. Such resources may include owned resources and, in at least some embodiments, borrowed resources. The resources that are associated with an entity may be grouped into various buckets. Some such buckets may, for example, represent individual resource accounts. For example, an entity may be associated with one or more resource accounts. At least some of the resources may be borrowed, supplemental, or scaled resources. The resources may, for example, represent an amount of a resource that is available for transfer, use or consumption. The entity that is associated with the client device 110 and the account may be a customer of an institution that operates or manages the first computing system 130.

The first system 130 may have access to other data such as, for example, resource availability data and/or historical resource or event data. Such data may be stored in the database 180 or in another storage system and/or may be accessed from another resource associated with the first computing system 130 such as, for example, one or more processors which may provide real-time resource availability data.

The first computing system 130 may also store data regarding a mapping of an identifier associated with a resource demand (e.g. a transferor, recipient and/or account identifier) to an identifier of the second system 140 (e.g. an Internet Protocol (IP) address or domain name). The mapping may be stored in the first data store 131.

The first system 130 may include several additional components. For example, the system 130 may include a natural language processing (NLP) engine and an adjudication engine.

The natural language processing engine may be adapted to unstructured, natural language content or data in text. The input to the natural language processing engine may include a value of one or more parameters of a resource demand. In particular, the value may be natural language, free-form text. The natural language processing engine may identify, based on the text, an intended purpose. The intended purpose may be considered the result of applying a mapping between unstructured text describing the purpose and a set of possible classifications (defined purposes) to the free-form text. Put another way, it is possible that, in some implementations, the natural language processing engine serves to classify the text into a set of classifications corresponding to defined purposes. The natural language processing engine may detect, for example, a particular category of a purpose that is conveyed in the content. The natural language processing engine may facilitate scaling a resource in a reasonable time or in real-time in response to an identification of a scaling request.

The natural language processing engine may operate in a variety of manners and may, in some embodiments, employ known natural language processing techniques. For example, support vector machines (SVMs) and/or convolutional neural networks (CNNs) may be employed by the natural language processing engine. In some implementations, the natural language processing engine may correspond to and/or may employ one or more commercially-available machine learning-based software packages or services for natural language classification and/or understanding. For example, one or more of the IBM Watson™ Natural Language Classifier or IBM Watson™ Natural Language Understanding available from International Business Machines Corp (IBM) of Armonk, N.Y., USA; the Microsoft Language Understanding Intelligence Services (LUIS) available from Microsoft Corporation of Redmond, Wash., USA; and/or Apache OpenNLP available from the Apache Software Foundation of Forest Hill, Md., USA, may be employed in a given implementation of the natural language processing engine. In a particular example, the natural language processing engine may employ one or more natural-language processing neural networks. Such neural networks and, more broadly, the natural language processing engine 202 may, in some embodiments, be trained, at least initially using a training set (a data set for training) including training data describing the purpose and/or resource demand and corresponding pre-determined categories. Some or all of that training data may correspond to the circumstances of hypothetical purposes. The corresponding categories and/or determinations of categories may be determined in a variety of manners including, for example, by trained experts reviewing that training data and/or the circumstances of the corresponding hypothetical and/or historical resource demand events and applying purpose-determination rules.

In some embodiments, the adjudication engine may include a large language model (LLM) trained to perform natural language processing tasks such as classification. The large language model may also be used for generative artificial intelligence (AI) to generate text from media including natural language content. For example, generative artificial intelligence may be used to generate a determination of a likelihood of an a positive outcome of a purpose of a resource demand.

In some implementations, the large language model may correspond to and/or may employ one or more commercially-available language model software packages or services. For example, one or more of OpenAI's GPT series of models available from OpenAI of San Francisco, California, USA and/or the Gemini family of multimodal large languages models available from DeepMind Technologies Limited of London, England may be employed in a given implementation of the language model.

The second system 140 may be managed, operated, controlled by and/or associated with an entity that is an agent of a second account holder. The second account holder may also be a customer (e.g. a corporate/business customer) or client of the entity or otherwise associated with the entity. In some embodiments, the second account holder is a requestor or transferee of a data transfer.

The second system 140 may further store data regarding users or customers associated with the second system 140 in second data store 141. The second data store 141 may include records associated with a plurality of entities. For example, the records may be for a plurality of accounts and at least some of the records may define or store resources. For example, the records may define a quantity of resources.

The first and second systems 130, 140 may be or include a transfer processing system. A transfer processing system may include a transfer processing module implemented as a software module and configured to process a transfer such as a transfer identified in a transfer message. By way of example, the processing module or system may be configured to perform internal transfers by transferring a resource or value between two different records in the first data store 131 (i.e., between two accounts at the same institution or entity) and/or to perform external transfers by interacting with one or more other third-party systems, such as, for example, second system 140. Internal and/or external transfers may be performed using various real-time methods, protocols, interfaces and/or techniques. In some implementations, at least some transfers may be performed by interacting with other systems via a third-party network. A transfer may be successfully processed and completed when value/resources have been successfully transferred from a transferor account to a recipient account. The processing system may track and store data identifying completed transfers.

As illustrated, the first system 130 is in communication with the client device 110 and second system 140 via the network 120. The client device 110, first system 130 and/or second system 140 may be configured to transmit and receive messages between each other.

The client device 110, first system 130, and second system 140 may be configured to ingest data from each other and may transmit requests, replies, alerts, notifications, configuration objects, or other data to each other. The first and second systems 130, 140 may store data in the first and second data stores 131, 141, respectively. The client device 110 may obtain data stored in the data store 131 via the first system 130. The first and second data stores 131, 141 are illustrated as single units for ease of illustration, but may include a plurality of storage units and, in some cases, storage media connected via the network 120.

The client device 110 is a computing device and may be configured to receive input and display output. It may, as illustrated, be a smart phone. However, the client device 110 may be a computing device of another type such as, for example, a mobile device, a desktop computer, a laptop computer, a tablet computer, a notebook computer, a hand-held computer, a personal digital assistant, a portable navigation device, a mobile phone, a wearable computing device (e.g., a smart watch, a wearable activity monitor, wearable smart jewelry, and glasses and other optical devices that include optical head-mounted displays), an embedded computing device (e.g., in communication with a smart textile or electronic fabric), and any other type of computing device that may be configured to store data and software instructions, and execute software instructions to perform operations consistent with disclosed embodiments.

The first and second systems 130, 140 may be or include a computer system such as a computer server system, database management system, resource management system, data transfer system, or resource transfer systems. A computer server system may, for example, be a mainframe computer, a minicomputer, or the like. In some implementations thereof, a computer server system may be formed of or may include one or more computing devices. A computer server system may include and/or may communicate with multiple computing devices such as, for example, database servers, web servers, email servers, file transfer protocol (FTP) servers, compute servers, and the like. Multiple computing devices such as these may be in communication using a computer network and may communicate to act in cooperation as a computer server system. For example, such computing devices may communicate using a local-area network (LAN). In some embodiments, a computer server system may include multiple computing devices organized in a tiered arrangement. For example, a computer server system may include middle tier and back-end computing devices. In some embodiments, a computer server system may be a cluster formed of a plurality of interoperating computing devices.

The client device 110, first system 130, and second system 140 may be in geographically disparate locations.

The network 120 is a computer network. The network 120 may be an internetwork such as may be formed of one or more interconnected computer networks. For example, such a network may be or may include an Ethernet network, an asynchronous transfer mode (A™) network, a wireless network, or the like. In some implementations, the network 120 may be the Internet. One example of a wireless network is a cellular network. Another example of a wireless network is a close proximity (i.e. personal area) wireless network, sometimes referred to as a wireless personal area network (WPAN). Examples of WPANs include Bluetooth™ and Zigbee™. The network 120 may facilitate communication between the client device 110, first system 130 and second system 140.

As further described below, the client device 110, first system 130 and second system 140 may be configured with software to perform associated functions such as those described herein.

FIG. 1 illustrates the first system 130, and second system 140, and data stores 131, 141 as separate and distinct computing devices. However, these systems may not all be separate physical systems. For example, the first system 130 and the data store 131 may be implemented on a common physical device. As another example, the second system 140 and the data store 141 may be implemented on a common physical device. One or more of the client device 110, first system 130 and second system 140 may be managed, operated, and/or controlled by a same entity.

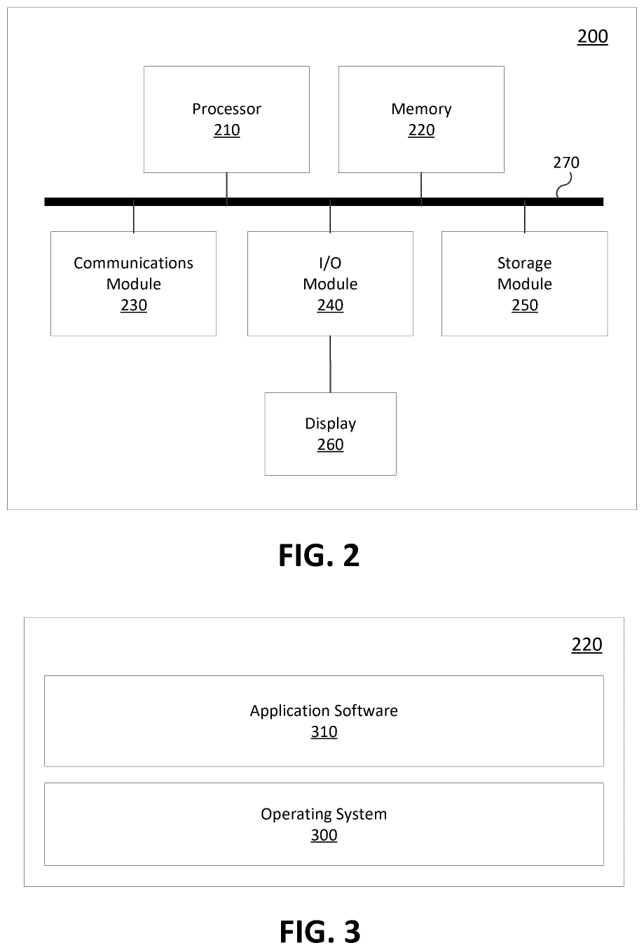

FIG. 2 is a high-level schematic diagram of an example computing device 200. In some embodiments, the example computing device 200 may be exemplary of the client device 110, first system 130 and/or the second system 140 in the example operating environment 100 of FIG. 1.

The example computing device 200 includes a variety of modules. A module may include one or more modules and may be a subsystem and/or include an interface. In some cases, a module is a hardware module and may be integrated into or include an electronic circuit.

As illustrated, the example computing device 200 may include a processor 210, a memory 220, a communications module 230, an I/O module 240, a storage module 250 and/or a display f. As illustrated, the foregoing example modules of the example computing device 200 are in communication over a bus 270. As such, the bus 270 may be considered to couple the various modules of the client device 110 to each other, including, for example, to the processor 210.

The processor 210 is a hardware processor. The processor 210 may, for example, be one or more ARM, Intel x86, PowerPC processors or the like.

The memory 220 allows data to be stored and retrieved. The memory 220 may include, for example, random access memory, read-only memory, and persistent storage. Persistent storage may be, for example, flash memory, a solid-state drive or the like. Read-only memory and persistent storage are a non-transitory computer-readable storage medium. A computer-readable medium may be organized using a file system such as may be administered by an operating system governing overall operation of the example computing device 200.710

The communications module 230 allows the example computing device 200 to communicate with other computing devices and/or various communications networks such as, for example, the network 120. For example, the communications module 230 may allow the example computing device 200 to send or receive communications signals. The communications module may be or include a network adapter, which may be wired or wireless. Communications signals may be sent or received according to one or more protocols or according to one or more standards. The communications module 230 may allow the example computing device 200 to communicate via one or more wireless networks, such as for example, a cellular wireless network, according to one or more standards such as, for example, Global System for Mobile Communications (GSM), Code Division Multiple Access (CDMA), Evolution Data Optimized (EVDO), Long-term Evolution (LTE), or 5G. Additionally or alternatively, the communications module 230 may allow the example computing device 200 to communicate via a wireless personal area network (WPAN) via some combination of one or more networks or protocols such as, for example, Bluetooth™ and Zigbee™. In some embodiments, all or a portion of the communications module 230 may be integrated into a component of the example computing device 200. For example, the communications module 230 may be integrated into a communications chipset or circuit.

The I/O module 240 is an input/output module. The I/O module 240 allows the client device 110 to receive input from and/or to provide input to components of the example computing device 200 such as, for example, various input modules and output modules. For example, the I/O module 240 may, as shown, allow the example computing device 200 to receive input from and/or provide output to the display 260.

The storage module 250 allows the example computing device 200 to store and retrieve data and, in some embodiments, may be referred to as a data store or data facility. In some embodiments, the storage module 250 may be formed as a part of the memory 220 and/or may be used to access all or a portion of the memory 220. Additionally or alternatively, the storage module 250 may be used to store and retrieve data from persisted storage other than the persisted storage (if any) accessible via the memory 220. In some embodiments, the storage module 250 may be used to store and retrieve data in/from a database. A database may be stored in persisted storage. Additionally or alternatively, the storage module 250 may access data stored remotely such as, for example, as may be accessed using a local area network (LAN), wide area network (WAN), personal area network (PAN), and/or a storage area network (SAN). In some embodiments, the storage module 250 may access data stored remotely using the communications module 230. In some embodiments, the storage module 250 may be omitted and its function may be performed by the memory 220 and/or by the processor 210 in concert with the communications module 230 such as, for example, if data is stored remotely. The storage module 250 is illustrated as a single unit for ease of illustration, but may include a plurality of storage units.

The example computing device 200 may include or be connected to a display 260. The display 260 is a module of the example computing device 200. The display 260 is for presenting graphics and displaying graphical user interfaces. The display 260 may be, for example, a liquid crystal display (LCD). In addition to being an output device, the display 260 may also be an input device. For example, the display 260 may allow touch input to be provided to the example computing device 200.

Software comprising instructions is executed by the processor 210 from a computer-readable medium. For example, software may be loaded into random-access memory from persistent storage of the memory 220. Additionally or alternatively, instructions may be executed by the processor 210 directly from read-only memory of the memory 220.

FIG. 3 depicts a simplified organization of software modules stored in the memory 220 of the example computing device 200 of FIG. 2. As illustrated, these software modules include an operating system 300 and application software 310.

The operating system 300 is software. The operating system 300 allows the application software 310 to access the processor 210, the memory 220, the communications module 230, the I/O module 240, and the storage module 250 of the example computing device 200. The operating system 300 may be, for example, Google™ Android™, Apple™ iOS™, UNIX™, Linux™, Microsoft™ Windows™, Apple OSX™ or the like.

The application software 310, when executed, co-operates with the operating system 300 to adapt the example computing device 200 for some purpose and to provide some defined functionality. For example, the application software 310 may cooperate with the operating system 300 to adapt a suitable embodiment of the example computing device 200 to serve as a client of, or provide a service to, another embodiment of the example computing device 200.

A software module may include or use one or more application programming interfaces (APIs). An application programming interface may facilitate communication between software modules and may be capable of transferring data or resources between software modules. For example, in some embodiments, the application programming interface may be used to connect to and transfer data or resources to and/or from one or more computing systems. The example computing device 200 may store connection data associated with the application programming interface, such as an identifier identifying a computing device or system. In some cases, the identifier may be or include a server identifier, such as, for example, an Internet Protocol (IP) address or domain name. The identifier may be used in conjunction with the application programming interface to establish a connection with the computing system.

The application programming interface may be configured to receive application programming interface requests that define parameters. The application programming interface may perform operations to obtain data or resources to fulfill the application programming interface requests.

The application programming interface may utilize a particular messaging protocol (e.g., a Representation State Transfer (REST) API (RESTful API) or a Simple Object Access Protocol (SOAP) API). Using the application programming interface may include generating a message in conformity with the particular messaging protocol for invoking the application programming interface.

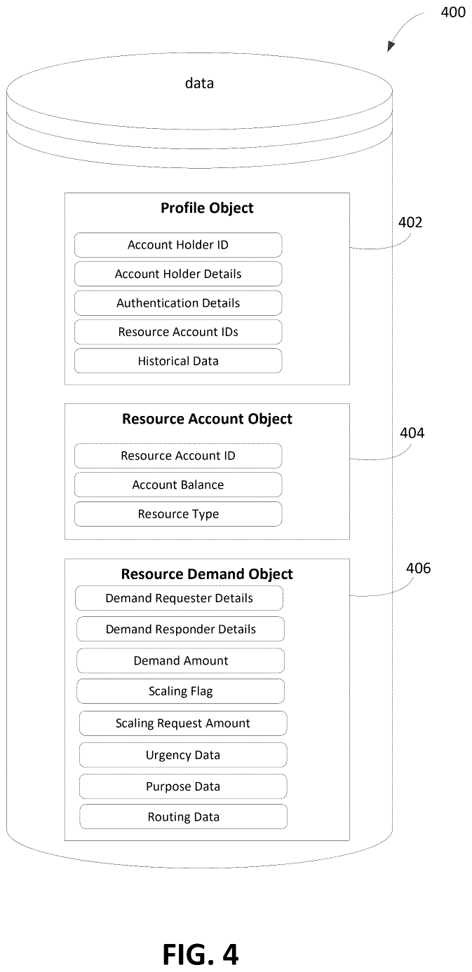

Reference is now made to FIG. 4, which partially illustrates an example data store 400 in block diagram form. The data store 400 may be a first or second data store 131, 141 of the first or second system 130, 140 of FIG. 1. Not all components of the data store 400 are illustrated. The data store 400 may include one or more data storage units. In some cases, the stored data may be in a database format and may include one or more databases. The databases may be relational databases in some examples. The data store may store data regarding one or more profile objects 402, resource account objects 404, and resource demand objects 406, each of which may be a data structure.

The data store 400 may store data regarding an account holder in a profile object 402. In some embodiments, the account holder may be or represent a user or customer. For instance, the account holder may correspond to a user of a client device 110 and/or first or second system 130, 140 of FIG. 1. The profile object 402 may include details related to the account holder, such as authentication details, one or more resource account identifiers, historical data, and resource demand details. A resource account identifier may correspond to a particular resource account object 404.

Example details related to an account holder include an account holder identifier indicating a particular person or entity, identification information (e.g. full name, including first and last name), contact information (e.g. phone number, email address, street address), and messaging information (e.g. phone number, email address).

Authentication details may include sign in or one more credentials such as, for example, username, password, access card number, shared secret, and/or biometric data such as a fingerprint, voiceprint and/or facial profile data. Authentication may be performed based on one or more credentials.

Historical data may include historical transfer data for transfers of resources to and/or from a resource account, and historical data corresponding to resource account events where the balance falls below a threshold, which may be zero.

The data store 400 may further store data regarding a resource account associated with a profile in a resource account object 404. The resource account object 404 may include a resource account identifier identifying a resource account. A resource account may hold or store resources for transfer to another resource account and may be a demand deposit account.

A resource account object 404 may also include an amount and/or type of resources associated with the resource account. The amount may reflect a quantity of resources that are available at any given time. Such resources may include owned resources and, in at least some embodiments, borrowed resources (e.g., resources obtained and made available via a loan). The quantity of resources that are available to or associated with a user may be reflected by a balance defined in an associated data record such as, for example, a resource account balance. The resource account balance may indicate an amount of resources available for immediate use or transfer by the account holder and/or from the resource account. An amount of a resource may be defined using a standard unit of measure. In some embodiments, a standard unit of measure for processor resources may be referred to as “processor units”.

The resources may be computing resources, which may be or include processor cycles, memory and/or network resources. The resources may take other forms in other implementations. By way of example, the resources that are associated with a resource account may be or may represent tokens, digital assets, physical assets, data, database assets, cryptocurrencies, value indicators, bandwidth, documents, images, photographs, streaming video, streaming audio, or other resources.

The data store 400 may further include a resource demand object 406 that may store data regarding a resource demand. The resource demand object may store details regarding one or more parameters includes in a resource demand message. Example parameters that may be included in a resource demand message include: a resource demand identifier identifying the particular resource demand; identification information of a type of resource demand (e.g. request for transfer, request for payment); deadline data (e.g. demand amount due date or transfer deadline); resource demand requester details (e.g. account holder identifier corresponding to account holder demanding the resource; resource account identifier corresponding that account holder identifier); resource demand responder details (e.g. account holder identifier corresponding to account holder that accepts the resource demand request and the scaling policy); a demand amount (e.g. an amount of resources demanded and/or to be transferred); a scaling flag; a supplemental amount (e.g. an amount to scale resources); urgency data; purpose data; and routing data.

The demand amount may sometimes be referred to as a resource demand amount and the supplemental amount may sometimes be referred to as a scaling request amount. The supplemental amount may be an amount that covers at least a portion of the resource demand amount or all of the resource demand amount. The supplemental amount may be less than, equal to, or greater than the resource demand amount. The supplemental amount and the resource demand amount may be distinct. For example, when a resource demand message represents a resource scaling request message, the resource scaling request message may have separate parameters for the demand amount and the scaling amount.

The scaling flag may indicate that the resource demand represents a resource scaling request. The resource scaling request may be provided as part of or within the resource demand message. The resource scaling request may be a request to scale a resource by being allocated or provided with a supplemental amount of a resource.

The urgency data may include an urgency level, which may indicate a level of urgency of the resource demand request and/or resource scaling request.

The purpose data may include a natural language text-based description of an objective or event corresponding to the resource demand, resource scaling request, and/or urgency data. The event may be past, current, or future event. In some cases, the purpose may provide details surrounding an urgency level. For example, if the urgency level is high, the purpose may provide details regarding an event that contributed to the high urgency level.

The routing data may include: identification information of the first and/or second system and/or the entity associated with, operating or managing the first and/or second system (e.g. a system identifier); and/or identification information of a first and/or second logical storage area, for example, a logical storage area identifier (e.g. a resource account identifier), associated with, managed or controlled by a respective first and/or second account holder to or from which the amount of resources is to be transferred. A logical storage area may be or include an area of the data store 400. A logical storage area may further be or represent a resource account or other logical storage area for storing an amount of a resource.

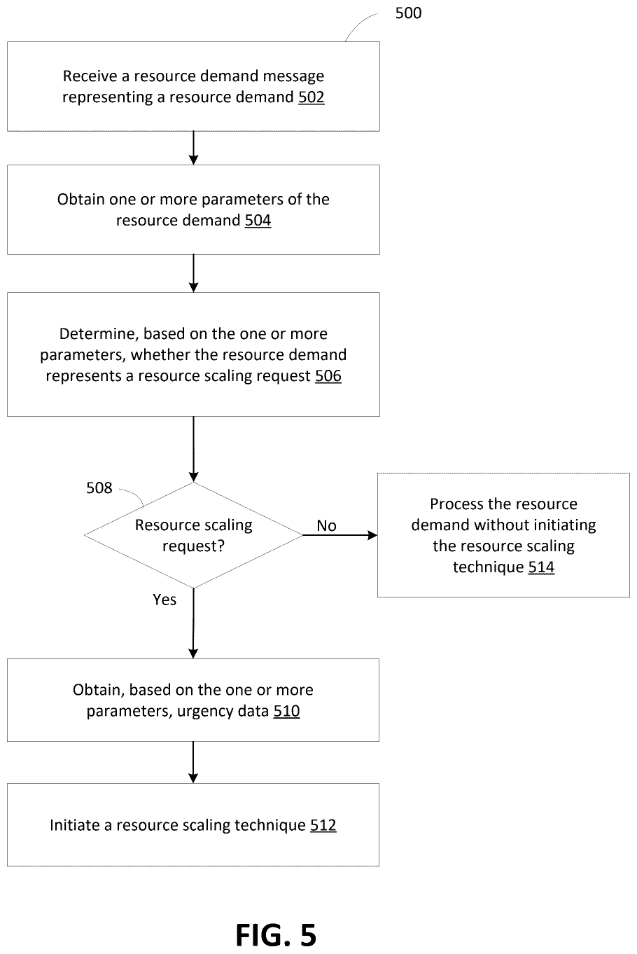

Reference will now be made to FIG. 5 which illustrates an example method 500 for scaling or supplementing a resource. The method 500 may be implemented by one or more computer systems suitably programmed to carry out the functions described. The operations of the example method 500 may be performed by one or more computer systems which may be of the type described herein. In some embodiments, the operations may be performed by the first system 130 of FIG. 1, which may cooperate and communicate with a client device 110 and/or a second system 140 of FIG. 1 in order to perform the method 500 or a variation thereof.

In operation 502, the computing system receives a resource demand. In some embodiments, the resource demand is in the form of a resource demand message representing the resource demand.

The resource demand message may be received, by the computing system from a second computing system that generates the resource demand message, in response to input received by the second computing system. The input to the second computing system may include a demand amount, a supplemental amount, purpose data and urgency data that may be included in the resource demand message.

The message may be formatted, and the elements may be arranged, using an industry-wide standardized template, or formatted and arranged without using an industry-wide standardized template. The message may be formatted in a real-time messaging format.

The resource demand and corresponding parameters may be received in various ways. For example, the system may include or be associated with a resource demand processing platform that allows software applications and/or computer systems to send resource demands to an account associated with a user of the computing system via the resource demand processing platform. In such instances, the system may receive the resource demand and/or parameters in a standardized format that allows for easy identification of necessary data such as a demand amount and a scaling amount.

In some embodiments, the resource demand may be received as a transfer message. The transfer message may represent a transfer of a resource from one account to another. The amount of resource may be expressed in various units. The computing system may process a transfer message, which may be a computer-readable message configured for transmission over one or more computer networks between a sending device and a receiving device. The transfer message may be a structured message having a defined schema or set of predefined fields to contain data. The transfer message may be used to transfer resources from one entity to another entity. In particular, the transfer message may be used to effect a change in recorded ownership of resources.

The transfer message is specially formatted to include parameters of a transfer. The parameters may be included as metadata in the transfer message. Where the request to transfer is a real-time message, the parameters may be included in a real-time protocol format. The parameters may include resource definition data. By way of example, the resource definition data may define a resource that is stored in or otherwise associated with a record associated with a transferor or recipient.

The transfer message may, in some implementations, be or include a request to transfer. A request to transfer may be a specially formatted message that is sent from a first transfer processing system to a second transfer processing system. The request to transfer may be sent from the first transfer processing system to the second transfer processing system over a transfer protocol that is used for facilitating transfers between databases associated with different transfer processing systems. For example, the first transfer processing system may be associated with a first database and the second transfer processing system may be associated with a second database. The databases may store account data. That is, the databases may store data that is associated with various accounts. In at least some implementations, each record in the database may be associated with a particular one of these accounts.

A request to transfer is a message that is sent on behalf of a recipient to initiate a transfer from a sender to the recipient. That is, the request to transfer is sent, on behalf of the recipient, from the transfer processing system associated with the recipient to the transfer processing system associated with the sender. The request to transfer requests a transfer from an account, for example a user account and/or a resource account, that is associated with the sender to an account that is associated with the recipient. The request to transfer includes one or more identifiers that identify the account associated with the sender and/or the record associated with the recipient. The identifier(s) may be or include an account number. The request to transfer may also include one or more identifiers that identify the transfer processing system associated with the sender and/or that identify the transfer processing system associated with the recipient. Such identifiers may be or include an entity or institution identifier.

The request to transfer is a transfer initiation message. That is, the request to transfer is an initial message that may be used to cause a transfer to occur. Since the request to transfer is initiated by a recipient rather than a sender, the request to transfer may be considered to a pull-style transfer, which may be contrasted with typical push-style transfers. In at least some implementations, the request to transfer may be formatted as an ISO20022 message.

In response to receiving the resource demand message, the computing system may extract, from the message, data identifying a resource demand. The extracted data may include the content of various fields of the message. The extracted data may be stored in a resource demand object 406 of the data store 400 of FIG. 4.

In operation 504, in response to receiving the resource demand message indicating the resource demand, the computing system may obtain one or more parameters of the resource demand message. The one or more parameters may include one or more variables to be used in the fulfillment of the resource demand. A parameter may include a name-value pair that includes a data value and a name that identifies the data value.

An example parameter that may be included in the data identifying the resource demand includes a flag to be used in determining whether a resource scaling request message is included in the resource demand message. A resource scaling request message may include an indication of a resource scaling request and may represent a resource scaling request.

In some embodiments, the flag may indicate whether a resource demand supports being fulfilled using a supplemental or scaled resource. In some embodiments, the presence of the flag enables initiation of a resource scaling technique in response to receiving the resource demand.

In operation 506, the computing system may determine, based on the one or more parameters of the resource demand message, that the resource demand message represents a resource scaling request message. The determination may include a determination of whether the one or more parameters include a flag (or similar indication) indicating that the resource demand represents a resource scaling request, that a special handling procedure may be performed in response to the resource demand, and/or the resource demand may be fulfilled using a resource scaling technique. The flag may include a value of a binary variable. The flag may allow a computing system that receives the resource demand message to interpret the message as a resource scaling message and to initiate a special handling procedure that would not be provided for ordinary resource demand messages. For example, when the computing system receives a message with the flag, the computing system may perform a special handling procedure that uses a resource scaling technique to fulfill the resource demand represented by the resource demand message.

In operation 508, in response to determining that the resource demand message includes the flag and represents a resource scaling request message, the computer system may in operation 510 obtain urgency data and in operation 512 initiate, use and/or perform a special handling procedure that may not be provided for an ordinary resource demand message that does not represent a resource scaling request message. The special handling procedure may include initiation, performance, and/or use of a resource scaling technique. Otherwise, in operation 514, the computing system may process the resource demand without initiating or performing the special handling procedure. For example, the computing system may fulfil the resource demand without initiating and/or performing the resource scaling technique.

In some embodiments, in operation 510, the computing system may obtain, based on the one or more parameters, urgency data. In some embodiments, the one or more parameters of the resource demand may include a parameter specifying urgency data. The urgency data may be a flag or a time indicator indicating the urgency of the request. For example, some resource scaling requests may be for procedures that need to be performed immediately, whereas other requests may be for procedures that need to be performed in the future. The second computing system may use the urgency data to flag requests that require urgent handling the first computing system, which receives the resource demand message from the second computing system, may use the urgency data in handling the resource demand. For example, the urgency data may be used in prioritizing handling of requests. That is, the computing system may attend to more urgent requests more quickly than it will attend to less urgent requests.

In operation 512, the computing system may initiate performance of the special handling procedure. The initiation of the special handling procedure may be based on the urgency data. In some embodiments, the urgency data indicates a level of urgency. For example, if the level of urgency is high, then the computing system may initiate, use and/or perform the resource scaling technique in real-time in response to receiving the resource demand. The computing system may also fulfil the resource demand and/or resource scaling request in real-time in response to receiving the resource demand.

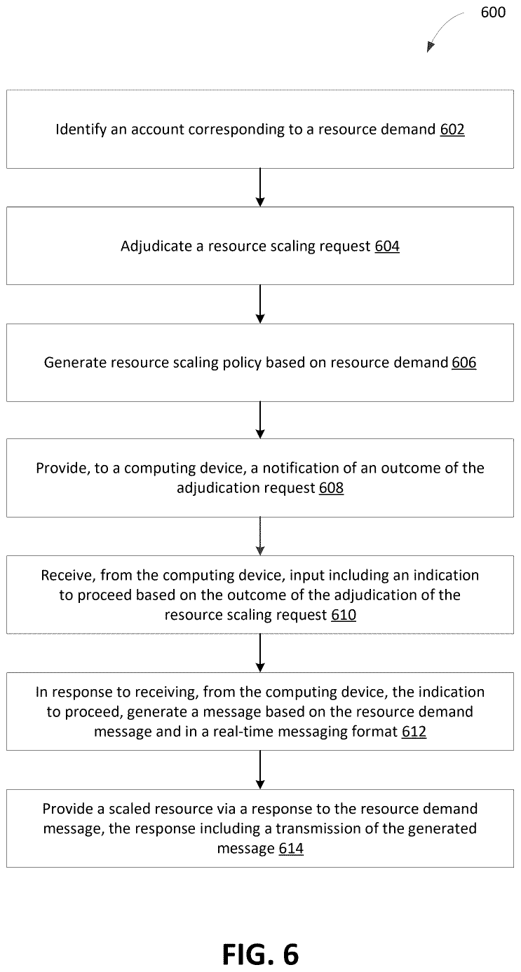

The operation 512 may correspond to the method 600 of FIG. 6 and the method may continue as shown in FIG. 6. If the resource demand message is not specially marked to indicate that it is a resource scaling request, then in operation 514 the system may not perform at least some of the operations of the method 600 FIG. 6. For example, if the resource demand message is an ordinary resource demand message, then the system may not determine whether a resource scaling request is approved.

Reference will now be made to FIG. 6 which illustrates an example method 600 for performing a resource scaling technique. The method 600 may be a modification or implementation of operation 512 of the method 500 of FIG. 5. For example, the resource scaling technique initiated in operation 512 of the method 500 of FIG. 5 may correspond to the resource scaling technique performed in the method 600 of FIG. 6. One or more operations of the method 500 of FIG. 5 may be responsive to one or more operations of the method of FIG. 6.

The resource scaling technique may implement a two-stage approval process. In general, in a first stage of approval, the system may automatically, without human intervention, and in real-time, adjudicate the resource scaling request. If the system approves the resource scaling request, the system may generate a scaling policy. In a second stage of approval, the system may transmit a notification prompting for input including an indication of acceptance of the scaling policy and an indication to proceed with the fulfilment of the resource scaling request in accordance with the scaling policy.

In operation 602, the computing system may identify a resource account and/or a user account corresponding to the resource demand. The identification may be performed based on the one or more parameters of the resource demand message. The one or more parameters may include a user account identifier (e.g. account holder profile identifier of the resource demand responder) identifying a recipient of the resource demand message, as well as a resource account identifier associated with the recipient account holder identifier. In some cases, if only one of the user account identifier and the resource account identifier is included in the resource demand message, the computing system may use that identifier to conduct a search of the profile objects 402 in the data store 400 of FIG. 4 to determine the other identifier.

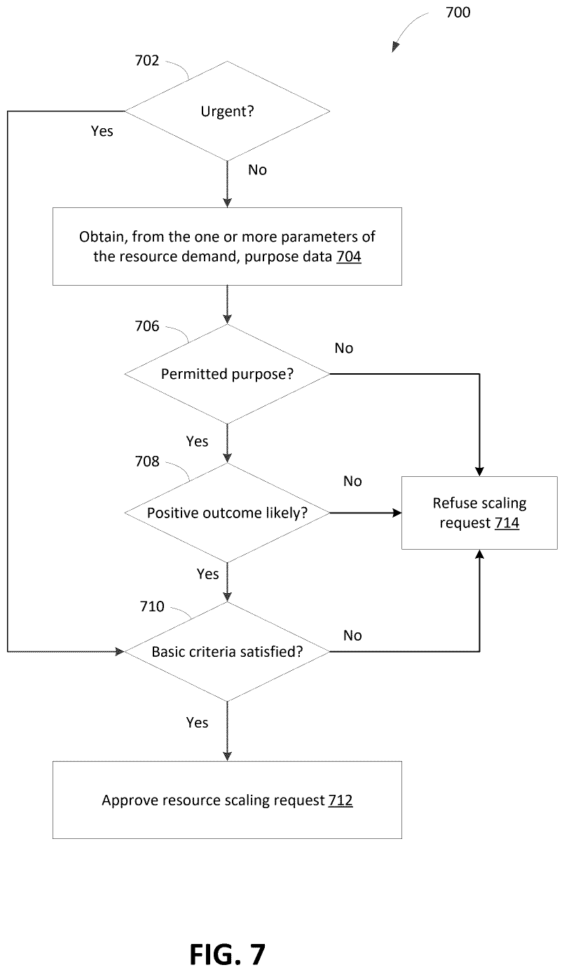

In operation 604, the computing system may automatically adjudicate the resource scaling request in real-time. In some embodiments, the adjudication may be performed according to the method 700 of FIG. 7. The outcome of the adjudication may be that the computer system approves or refuses the request.

In operation 606, if the outcome of the adjudication of the resource scaling request is positive and the request is approved, the computing system may automatically generate a scaling policy. The scaling policy may specify the terms and conditions for fulfilling the resource scaling request. The policy may be based on, or include one or more of, the one or more parameters of the resource demand. In some cases, the policy may specify the amount of supplemental resources that have been approved to fulfill the request. In the case where the resource scaling request is a request to borrow a supplemental amount of resources, the policy may also specify terms and conditions for the return of the supplemental amount of resources.

In operation 608, responsive to adjudicating the resource scaling request and generating the scaling policy, the computing system may provide a notification, in real-time (or substantially real-time), of the outcome of the adjudication of the resource scaling request to a computing device associated with the identified user account and/or resource account. In some embodiments, the computing device may correspond to the client device 110 of FIG. 1.

The notification may also provide, directly or indirectly, details of the scaling policy, which may include terms and conditions. Details of the scaling policy may be provided directly by including the details in the notification, or indirectly by including a link to the details.

The computer system may transmit the notification based on the resource demand, resource scaling request, adjudication outcome, and the identified user and/or resource accounts.

The computing system may use a messaging address to transmit the notification to the computing device. In some embodiments, the messaging address may be obtained from the identified user account.

The transmission of the notification may be performed in accordance with any suitable means of communication. In some embodiments, the communication may be implemented using a messaging paradigm, such as email, text message, instant message, automated telephone call, or messaging to an application relating to the identified account. Information of the identified user account may be used to transmit the notification to the client device. In some embodiments, the computing system may transmit the notification to the client device using a messaging address, for example, an email address and/or a telephone number, associated with the identified one or more accounts.

The notification may be provided in different forms and the message of the notification may vary. The notification may include information of the matched user account, such as the account identifier. The notification may also include details of the resource demand, resource scaling request, adjudication outcome, identified resource account, and/or identified user account. In some embodiments, the message may be a rich Hypertext Transfer Protocol (HTTP) email, pure text email or short messaging service (SMS) message.

The identified user account may be associated with the client device. For instance, the client device may be configured with information of the identified user account in order to receive notifications from the computing system. In some embodiments, the client device may include an email application that is configured to receive emails addressed to an email address of the identified account. The client device may also be configured to receive text messages and telephone calls at a telephone number of the identified account. In some embodiments, the client device may be configured to receive a notification via an application that relates to the identified account and is installed on the client device. The application may be, for example, a resource management application that is configured with credentials (e.g. a username and password) of the identified account for authenticating the application with the computing system. The computing system may transmit the notification to the authenticated resource management application.

The computing device may present the notification to a user of the computing device via a user interface. The user interface may be that of a messaging application, such as an email application, text and/or voice message application, instant message application, or an application relating to the identified account. In some embodiments, the user interface may be a graphical user interface that presents the notification via pop-up, alert, or in any other suitable manner. The notification may present details of the scaling policy or a link to details of the scaling policy. The notification may also prompt for input including an indication to proceed based on the outcome of the adjudication of the resource scaling request and to accept the scaling policy. The prompt may be presented as a link, button or other actionable user interface element and may include text.

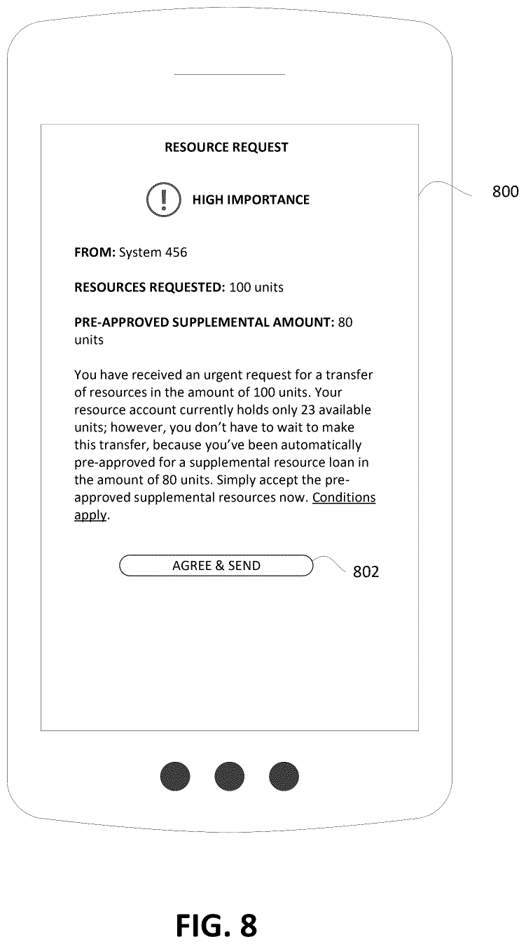

Referring briefly to FIG. 8, an example notification input interface 800 is illustrated. The notification input interface 800 may be displayed on a display of the computing device. The notification input interface 800 may include a message that is provided by the notification or is generated based on the notification. The notification includes text indicating a resource demand amount of 100 units, a supplemental resource amount of 80 units, and a resource account balance of 23 units. The notification interface 800 also includes a selectable option 802. The selectable option 802 may be activated in order to trigger the computing system to process the resource scaling request to initiate fulfillment of the resource scaling request. The selectable option 802 may be associated with a reference or uniform resource identifier (URI) that links to the computing system. The selectable option 802 may be a link for triggering the computing device to send to the computing system an indication to proceed with fulfilling the resource scaling request and to accept the resource scaling policy.

The notification may facilitate authorization of the scaling request without requiring input of one or more parameters that may be required to fulfil the scaling request. By way of example, one or more parameters that are included the resource demand may be included in the notification so that the user of the computing device does not have to input such parameters. In some implementations, the resource demand may define the resource and the amount to scale. In this way, the user of the computing device may authorize the resource scaling request without inputting information defining the resource or amount involved.

Referring back to FIG. 6, in operation 610, the computer system may receive in input including an indication: of actuation of the selectable option; to proceed based on the outcome of the adjudication of the resource scaling request; and/or acceptance of the resource scaling policy.

In operation 612, in response to receiving input including an indication of actuation of the selectable option and to proceed based on the outcome of the adjudication of the resource scaling request, the computing system may take one or more actions.

The one or more actions may include fulfilling the resource scaling request, generating a message, and performing a transfer of resources. The one or more actions may be performed in real-time.

Fulfilling the resource scaling request may include scaling a resource by allocating the supplemental amount of resources to the identified resource account. In some embodiments, fulfilling the resource scaling request may include performing a database operation to reflect an adjustment of an amount of resources available in a resource account. The adjustment may be in the amount of the supplemental amount and the resource account may be the identified resource account.

In some embodiments, the computing system may generate a message based on the resource demand message.

The generated message may be formatted, and the elements may be arranged, using an industry-wide standardized template, or formatted and arranged without using an industry-wide standardized template. The message may be formatted in a real-time messaging format.

The generated message may be sent as a transfer message. The transfer message may represent a transfer of a resource from one account to another. The amount of resources may be expressed in various units. The transfer message may be a structured message having a defined schema or set of predefined fields to contain data. The transfer message may be used to transfer resources from one computer system to another computer system, and/or from one entity to another entity. In particular, the transfer message may be used to effect a change in recorded ownership of resources.

The transfer message is specially formatted to include parameters of a transfer. The parameters may be included as metadata in the transfer message. Where the transfer message is a real-time message, the parameters may be included in a real-time protocol format. The parameters may include resource definition data. By way of example, the resource definition data may define a resource that is stored in or otherwise associated with a record associated with a transferor or recipient. In at least some implementations, the transfer message may be formatted as an ISO20022 message.

The computer system may include an application programming interface capable of and/or configured to perform resource transfers in real-time or facilitate a real-time transfer. The application programming interface may utilize a particular messaging protocol that supports real-time resource transfers. The generated message may be in conformance with a particular messaging protocol for invoking the application programming interface. In some embodiments, both the resource demand message and the generated message may use an application programming interface that is configured to facilitate a real-time transfer. The computing system may receive the resource demand message and send the generated message using the same application programming interface and same real-time transfer protocol.

Parameters that may be included in a generated message may include at some of the data or parameters included in the resource demand message, such as those stored in a resource demand object 406 in the data store 400 of FIG. 4. Example parameters that may be included in the generated message include the demand amount, resource demand requester details, resource demand responder details (e.g. details of the identified user account and/or resource account), and routing data.

The generated message may be a transfer message for transferring the demand amount from the identified resource account, which may include the supplemental amount of resources, to a destination specified by the resource demand. The destination may be specified by the resource demand requested details included in the resource demand, which may specify a destination resource account and/or computing system.

In some embodiments, the generated message may include routing data obtained based on one or more parameters of the resource demand message. The computing system may map one or more parameters of the resource demand to a system identifier of a corresponding system. In some implementations, the computing system may use a look-up table to map possible values of an account holder identifier included in the resource demand requester details, or another identifier included in a resource demand, to a server and/or system. For example, such a look-up table may map recipient identifiers to system identifiers. In some implementations, the computing system may operate in some other manner than using a look-up table. In some implementations, the mapping operation may be omitted such as, for example, if the resource demand includes a system identifier suitable for routing the generated message.

In operation 614, the computing system may provide a scaled resource via a response to the resource demand. The response may include a transmission of the generated message.

The computer system may provide a scaled resource by transferring the resource demand amount from a resource account that has been allocated, or otherwise provisioned with, the supplemental amount of resources included in the resource demand message. The supplemental amount may be sufficient to cover at least a portion of the demand amount, with any remaining amount being covered by the resource account balance that was available prior to the allocation of the supplemental amount to the resource account.

The transfer may be effected by a transmission of the generated message, and the resource demand may be considered fulfilled by the performance and completion of the transfer of the demand amount.

The computer system may use an application programming interface, which is configured to facilitate a real-time transfer, to transmit the generated message using a real-time transfer protocol. In this way, the resource demand may be fulfilled in real-time in response to receiving the input indicating approval to proceed with fulfilling the resource scaling request.

Reference will now be made to FIG. 7 which illustrates an example method 600 for adjudicating a resource scaling request. The method 700 may be a modification or implementation of operation 604 of the method 600 of FIG. 6. For example, the adjudication in operation 604 of the method 600 of FIG. 6 may correspond to the adjudication performed in the method 700 of FIG. 7. One or more operations of the method 700 of FIG. 7 may be responsive to one or more operations of the methods 500, 600 of FIGS. 5 and 6.

In operation 702, the computing system may determine whether the resource scaling request is urgent. The determination may be based on urgency data included in the resource demand message. In some embodiments, the computing system may have different handling procedures for urgent requests than for non-urgent requests. For example, the system may skip one or more operations for at least some urgent requests that would not be skipped for non-urgent requests. In this way, the system may perform a more rapid adjudication algorithm for urgent requests than for non-urgent requests. For example, if the request is urgent, the system may in operation 710 determine whether a first set of criteria is satisfied. Otherwise, the system may determine evaluate in operations 706, 708, 710 one or more criteria in addition to the basic set of criteria, or evaluate a more advanced set of criteria. The advanced set of criteria may be more resource intensive than the basic set of criteria.

In operation 704, the computing system may obtain purpose data corresponding to the resource scaling request from the one or more parameters of the resource demand. For example, the resource scaling request message may include a field indicating a purpose of the resource scaling request. The content of that field may be referred to as purpose data. The computing system may use the purpose of the resource scaling request to adjudicate the resource scaling request. For example, in operation 706, the computing system may evaluate whether the resource scaling request is for a permitted purpose.

In some embodiments, the purpose data defines a category of a purpose of the resource scaling request. The system may compare the defined category with a list of defined categories of permitted purposes, and based on the comparison, determine whether the purpose is a permitted purpose. For example, if the defined category matches a particular defined category in the list of defined categories, then the resource scaling request is for a permitted purpose.

In some embodiments, the purpose data may be or include free-form, unstructured text. In this case, the system may use natural language processing to extract, from the purpose data, a category of a purpose. The system may determine, based on the extracted category and/or the list of defined categories of permitted purposes, whether the request is for a permitted purpose.

If the resource scaling request is not for a permitted purpose, the system may in operation 714 refuse the resource scaling request. Otherwise, the system may in operation 708 determine whether a purpose defined by the resource scaling request has a probable positive outcome.

For instance, in some embodiments, the purpose data may indicate a specific procedure that is to be performed using a scaled resource provided in response to the resource scaling request. As part of the adjudication process, the computing system may determine whether that procedure has a probable positive outcome. For example, if the resource scaling request is to scale CPU resources in the amount of an additional 1024 CPU units and the purpose of the request is to run a specific, complex decryption algorithm, then the computing system may determine, based on stored data or based on a large language model, a likelihood of a positive outcome. In some embodiments, an outcome may be considered positive if the demand amount and/or the supplemental amount is sufficient to perform the specific procedure.

Where the determination is based on a large language model, a natural language request, which may be referred to as a prompt, may be submitted to the model to receive a response back. The prompt may include contextual information, which may include the purpose data. The prompt may also include a query as to whether, in the context of the purpose data and/or resource demand, the fulfillment of the resource scaling request is likely to lead to a positive outcome. An outcome may be considered positive if the supplemental amount is used to successfully accomplish a goal aligned with the purpose of the resource scaling request.

If the likelihood of a positive outcome is not sufficiently high, then the system may in operation 714 decline the resource scaling request but if it is sufficiently high (and if other criteria are satisfied), then the system may in operation 712 approve the resource scaling request.

In operation 710, the computing system may determine whether a set of criteria is satisfied. The criteria may be based on a set of one or more factors including the demand amount, the supplemental amount, creditworthiness data corresponding to the identified profile, and/or a resource account balance of the corresponding to the identified account. The creditworthiness data may represent a prediction of how likely the account holder is to pay for or return a resource provided in response to a resource scaling request. The creditworthiness data may be based on one or more factors including historical resource account data and events. Example historical resource account data may include, and/or historical balance events corresponding to negative resource account balances.

In some embodiments, each particular factor in the set of one or more factors may be compared to a respective threshold. The resource scaling request may be approved or refused based on the individual comparisons. For example, if the demand amount or scaling amount exceed a respective threshold, then the request may be refused. Similarly, if the creditworthiness or resource account balance fail to meet a respective threshold, then the request may be refused.

If a particular criteria in the set of criteria is not satisfied, the system may in operation 714 refuse the resource scaling request. Otherwise, if all of the criteria in the set of criteria are satisfied, the system may in operation 714 automatically approve the resource scaling request.

The method 700 may continue in operation 604 as shown in FIG. 6. The system may perform at least some aspects of the method 600 in FIG. 6 in accordance with at least some aspects of the method 700 of FIG. 7.

It will be appreciated that it may be that some or all of the above-described operations of the various above-described example methods may be performed in orders other than those illustrated and/or may be performed concurrently without varying the overall operation of those methods.

It will also be appreciated that some or all of the above-described operations of the various above-described example methods may be triggered by, or caused by, or performed in response to, one or more of the above-described operations, and may be performed in real-time (or substantially real-time) in response to one or more of the above-described operations and/or automatically without user input.

Although many of the above examples refer to an “object” when discussing a data structure, it will be appreciated that this does not necessarily restrict the present application to implementation using object-oriented programming languages, and does not necessarily imply that the data structure is of a particular type or format. Data structures may have different names in different software paradigms.

Example embodiments of the present application may focus on a particular type of resource. However, it is understood that the present application is not limited to any such embodiments and that the embodiments described with respect to a particular type of resource generally may be extended to other types of resources.

Example embodiments of the present application are not limited to any particular operating system, system architecture, mobile device architecture, server architecture, or computer programming language.

It will be understood that the applications, modules, routines, processes, threads, or other software components implementing the described method/process may be realized using standard computer programming techniques and languages. The present application is not limited to particular processors, computer languages, computer programming conventions, data structures, or other such implementation details. Those skilled in the art will recognize that the described processes may be implemented as a part of computer-executable code stored in volatile or non-volatile memory, as part of an application-specific integrated chip (ASIC), etc.

As noted, certain adaptations and modifications of the described embodiments can be made. Therefore, the above discussed embodiments are considered to be illustrative and not restrictive.

1. A computer system comprising:
a communications module;
one or more processors coupled to the communications module; and
a memory coupled to the one or more processors and storing instructions that, when executed by the computer system, cause the computer system to:
obtain one or more parameters of a resource demand message;
determine, based on the one or more parameters of the resource demand message, that the resource demand message represents a resource scaling request message; and
in response to determining that the resource demand message represents a resource scaling request message, initiate a resource scaling technique, the resource scaling technique including:
adjudicating a resource scaling request indicated by the resource scaling request message;
providing a notification of an outcome of the adjudication of the resource scaling request to a computing device;
in response to receiving, from the computing device, input including an indication to proceed based on the outcome of the adjudication of the resource scaling request, generating a message based on the resource demand message and in a real-time messaging format; and
providing a scaled resource via a response to the resource demand message, the response including a transmission of the generated message.

2. The computer system of claim 1, wherein the resource demand message includes urgency data indicating an urgency of the resource demand message and wherein the resource scaling technique is based on the urgency of the resource demand message.

3. The computer system of claim 1, wherein the instructions further cause the computer system to prioritize initiating the resource scaling technique based on an urgency of the resource demand message.

4. The computer system of claim 1, wherein adjudicating the resource scaling request is based on a purpose indicated by the one or more parameters of the resource demand.

5. The computer system of claim 1, wherein adjudicating the resource scaling request is based on a likelihood of a positive outcome to use of the scaled resource.

6. The computer system of claim 1, wherein adjudicating the resource scaling request is based on a resource scaling amount included in the resource demand message.

7. The computer system of claim 1, wherein the one or more parameters of the resource demand message indicate a resource demand amount and a scaling request amount to cover at least a portion of the resource demand amount.

8. The computer system of claim 1, wherein the transmission of the generated message includes use of an application programming interface configured to facilitate a real-time transfer.

9. The computer system of claim 1, wherein the instructions further cause the computer system to receive the resource demand message via a real-time transfer protocol.

10. The computer system of claim 1, wherein the instructions further cause the computer system to generate a resource scaling policy based on the resource demand message, and wherein the indication to proceed further indicates acceptance of the resource scaling policy.

11. A computer-implemented method comprising:
obtaining one or more parameters of a resource demand message;
determining, based on the one or more parameters of the resource demand message, that the resource demand message represents a resource scaling request message; and
in response to determining that the resource demand message represents a resource scaling request message, initiating a resource scaling technique, the resource scaling technique including:
adjudicating a resource scaling request indicated by the resource scaling request message;
providing a notification of an outcome of the adjudication of the resource scaling request to a computing device;
in response to receiving, from the computing device, input including an indication to proceed based on the outcome of the adjudication of the resource scaling request, generating a message based on the resource demand message and in a real-time messaging format; and
providing a scaled resource via a response to the resource demand message, the response including a transmission of the generated message.

12. The method of claim 11, wherein the resource demand message includes urgency data indicating an urgency of the resource demand message and wherein the resource scaling technique is based on the urgency of the resource demand message.

13. The method of claim 11, further comprising prioritizing initiating the resource scaling technique based on an urgency of the resource demand message.

14. The method of claim 11, wherein adjudicating the resource scaling request is based on a purpose indicated by the one or more parameters of the resource demand.

15. The method of claim 11, wherein adjudicating the resource scaling request is based on a likelihood of a positive outcome to use of the scaled resource.

16. The method of claim 11, wherein adjudicating the resource scaling request is based on a resource scaling amount included in the resource demand message.

17. The method of claim 11, wherein the one or more parameters of the resource demand message indicate a resource demand amount and a scaling request amount to cover at least a portion of the resource demand amount.

18. The method of claim 11, wherein the transmission of the generated message includes use of an application programming interface configured to facilitate a real-time transfer.

19. (canceled)

20. A non-transitory computer-readable storage medium comprising processor-executable instructions which, when executed, configure one or more processors to:
obtain one or more parameters of a resource demand message;
determine, based on the one or more parameters of the resource demand message, that the resource demand message represents a resource scaling request message; and
in response to determining that the resource demand message represents a resource scaling request message, initiate a resource scaling technique, the resource scaling technique including:
adjudicating a resource scaling request indicated by the resource scaling request message;
providing a notification of an outcome of the adjudication of the resource scaling request to a computing device;
in response to receiving, from the computing device, input including an indication to proceed based on the outcome of the adjudication of the resource scaling request, generating a message based on the resource demand message and in a real-time messaging format; and
providing a scaled resource via a response to the resource demand message, the response including a transmission of the generated message.

21. The computer system of claim 1, wherein determining, based on the one or more parameters of the resource demand message, that the resource demand message represents a resource scaling request message uses natural language processing.
